(19) United States
(12) Patent Application Publication
(10) Pub. No.: US 2026/0186829 A1
(43) Pub. Date: Jul. 2, 2026

(54) VIRTUAL COMPUTER MANAGEMENT SYSTEM, SYNCHRONOUS SERVER, AND VIRTUAL COMPUTER MANAGEMENT METHOD

(71) Applicant: NTT, Inc., Tokyo (JP)

(72) Inventors: Hirofumi NOGUCHI, Tokyo (JP); Yuta KAZATO, Tokyo (JP)

(73) Assignee: NTT, Inc., Tokyo (JP)

(21) Appl. No.: 19/130,912

(22) PCT Filed: Nov. 22, 2022
(86) PCT No.: PCT/JP2022/043143

§ 371 Date: May 16, 2025

(51) Int. Cl. G06F 9/48

(52) U.S. Cl. CPC G06F 9/4881

(57) ABSTRACT

A virtual computer management system is configured including an active system management server and a backup system management server each configured to receive an operation request for operating a virtual computer. The virtual computer management system includes: a request generation unit that, when the result of a first operation request to the active system management server is a normal termination, converts the first operation request into a second operation request to the backup system management server; and a queue management unit that enqueues the second operation request in a queue and, when the result of a third operation request to the backup management server, located at the head of the queue, is a normal termination, deletes the third operation request from the queue and transmits an operation request newly located at the head of the queue to the backup system management server.

### CROSS-REFERENCE TO RELATED APPLICATION

This is a National Stage Application of PCT Application No. PCT/JP2022/043143, filed on Nov. 22, 2022. The disclosure of the prior application is considered part of the disclosure of this application, and is incorporated in its entirety into this application.

### BACKGROUND

### Technical Field

The present invention relates to a virtual computer management system, a synchronization server, and a virtual computer management method for provisioning virtual computers operating on a virtualization infrastructure with redundancy.

### Background Art

Operators that operate a large number of virtual computers, such as cloud computing providers or communication carriers, use a virtual computer management system for managing virtual computers. A virtual computer management system is a system that receives requirements on the performance of resources of a virtual computer and requirements on the network from a user and instantiates the virtual computer using a virtualization technology such as a virtual machine (VM) or a container. Some virtual computer management systems have functions of, in addition to instantiating and deleting a virtual computer, performing automatic scaling and restoration according to a load by monitoring a state.

As an example of a virtual computer management system, Industry Specification Group on Network Functions Virtualization (ISG NFV) of European Telecommunications Standards Institute (ETSI) defines one including a Representational State Transfer (Restful)-based interface (see Non-Patent Literature 1).

In this architecture, a component called virtual network function manager (VNFM) receives a request for creating a virtual resource as an application programming interface (API) server, and sends an instruction to a component that is called virtual infrastructure manager (VIM) and configured to instantiate a virtual resource. The VIM instantiates a virtual computer in the form of a VM or a container, and instantiates and sets a virtual network to be used by the virtual computer according to the request. This architecture, which is mainly for communication systems, enables management of a large number of virtual computers by reducing the burden of the user by the VNFM acting as a substitute for the user performing procedures for the complex requirement of a virtual computer and creating the virtual computer.

Incidentally, in general, a redundant configuration is adopted for a system which is represented by a communication system and requires high availability. The same applies to a case of using virtual computers. For example, in a case where a redundant configuration of two systems of an active system and a backup system is adopted, the states of the active system and the backup system are synchronized, and the system is switched to the backup system when a failure of the active system occurs, thereby preventing the entire system from stopping. Methods for synchronization between the active system and the backup system include a method of duplicating virtual computers of the active system in the backup system for example on a per-VM basis, and a method of notifying both the active system and the backup system of a user request to the virtualization management system, to perform processing. In particular, in a virtual computer management system including an API server that receives user requests, the latter method in which an operator or a user can ascertain the state of a virtual computer and recover the virtual computer on a per-API request (operation request on the virtual computer) basis has a great advantage. Note that the result of executing an API request can be managed according to the data model Virtualized Network function (VNF) Lifecycle Management (LCM) operation occurrences (see Non-Patent Literature 2), defined in the above-mentioned NFV standard.

### PRIOR ART LITERATURE

### Non-Patent Literature

Non-Patent Literature 1: ETSI ISG NFV, FIG. 4.1-1: The NFV-MANO architectural framework with reference points, ETSI GS NFV-IFA 009V 1.1.1 , p. 8 (2016-07), [online], [retrieved on Nov. 4, 2022], the Internet <URL:https://www.etsi.org/deliver/etsi_gs/nfv-ifa/001_099/009/01.01.01_60/gs_nfv-ifa009v010101p.pdf>
Non-Patent Literature 2: ETSI ISG NFV, 5.4.12 Resource: VNF LCM operation occurrences, ETSI GS NFV-SOL 003V 3.3.1 , pp. 85-87 (2020-08), [online], [retrieved on Nov. 4, 2022], the Internet <URL: https: //www. etsi. org/deliver/etsi_gs/NFV-SOL/001_099/003/03.03.01_60/gs_nfv-sol003v030301p.pdf>

### SUMMARY OF THE INVENTION

### Problems to be Solved by the Invention

However, consideration is required when performing synchronization between the active system and the backup system by duplicating an API request. One is that an appropriate system operation cannot be performed even if the same API request is simply reproduced in the backup system. Generally, virtual computers and virtual networks are managed and identified using unique identification information. As the identification information, a universally unique identifier (UUID) or the like that is randomly generated is often used in order to ensure uniqueness. That is, the same identification information is not assigned to the active system and the backup system even if they process the same API request. Further, in order to request a virtual computer to connect to a virtual network, it is necessary to specify such identification information, and thus even if the API request of the active system is duplicated in the backup system as is, it is not correctly processed.

In addition, it is also necessary to consider that an API request is not necessarily terminated normally. For example, in some cases, the processing is terminated abnormally due to a logical inconsistency in the parameters of the API request or due to a temporary network failure. When such an abnormal termination occurs only in the active system, only the state of the backup system transitions, resulting in a mismatch between the active system and the backup system. Depending on processing, restoration by an API request cannot be performed, and it is necessary to perform manual restoration on falling back of the backup system.

Note that VNF LCM operation occurrences are a data model corresponding to an API request on a one-to-one basis, and include success or failure of the result of executing the API request. In the case of failure, restoration processing can be executed by sending an API request for restoration, such as rollback or retry, with specifying identification information of the VNF LCM operation occurrences. As such, the VNF LCM operation occurrences are a design concept that is useful for state management of API request (operation request on a virtual computer), but are intended only for operations on the active system and cannot implement a redundant configuration by themselves.

The present invention has been made in view of such a background, and an object thereof is to duplicate an operation request for operating a virtual computer to enable synchronization between an active system and a backup system.

### Solution to Problem

In order to achieve the above object, an aspect of an embodiment according to the present invention is a virtual computer management system including: a request generation unit; and a queue management unit, wherein the request generation unit is implemented using one or more processors and configured to, when a result of an operation performed by an active system management server in response to a first operation request for operating a first virtual computer of an active system is a normal termination, convert the first operation request into a second operation request requesting a backup system management server to operate a second virtual computer of a backup system, and wherein the queue management unit is implemented using one or more processors and configured to: enqueue the second operation request in a queue; and when a result of an operation performed by the backup system management server in response to a third operation request located at a head of the queue is a normal termination, the third operation request requesting the backup system management server to operate a third virtual computer of the backup system, delete the third operation request from the queue and transmit an operation request newly located at the head of the queue to the backup system management server to request processing.

### Advantageous Effects of Invention

According to the present invention, it is possible to duplicate an operation request for operating a virtual computer to enable synchronization between an active system and a backup system.

### BRIEF DESCRIPTION OF THE DRAWINGS

FIG. 1 is an overall configuration diagram of a virtual computer management system according to the present embodiment.

FIG. 2 is a function block diagram of an active system management server according to the present embodiment.

FIG. 3 is a function block diagram of a synchronization server according to the present embodiment.

FIG. 4 is a data configuration diagram of a job management database according to the present embodiment.

FIG. 5 is a data configuration diagram of a virtual resource management database according to the present embodiment.

FIG. 6 is a sequence diagram of operation processing for a virtual computer of an active system according to the present embodiment.

FIG. 7 is a sequence diagram of operation processing for a virtual computer of a backup system according to the present embodiment.

FIG. 8 is a sequence diagram of restoration processing for the virtual computer of the active system according to the present embodiment.

FIG. 9 is a sequence diagram of restoration processing for the virtual computer of the backup system according to the present embodiment.

FIG. 10 is a flowchart of queue management processing according to the present embodiment.

FIG. 11 is a hardware configuration diagram illustrating an example of a computer that realizes functions of the synchronization server according to the present embodiment.

### MODES FOR CARRYING OUT THE INVENTION

### Configuration of Virtual Computer Management System

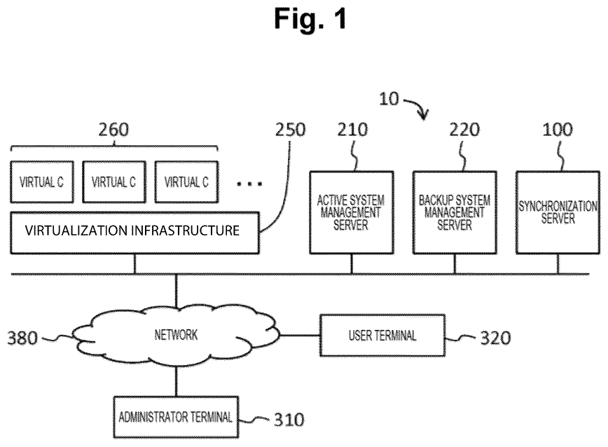

FIG. 1 is an overall configuration diagram of a virtual computer management system 10 according to the present embodiment. The virtual computer management system 10 is configured including an active system management server 210, a backup system management server 220, and a synchronization server 100. The virtual computer management system 10 may be configured to include a virtualization infrastructure 250 on which virtual computers 260 operates. Note that the virtual computer 260 is also denoted “Virtual C” in the drawings.

The virtual computer management system 10 is connected to a network 380. An administrator terminal 310 operated by an administrator of the virtual computers 260 and a user terminal 320 that accesses the virtual computers 260 to use services are connected to the network 380.

The administrator terminal 310 transmits an operation request for operating a virtual computer 260 to the active system management server 210 and receives an operation result. Examples of the operation request include instantiation, stop, and deletion of a virtual computer 260 of the active system, and instantiation and setting of a virtual network used by the virtual computer 260. The operation result can be a normal termination or an abnormal termination. In the case of an abnormal termination, the administrator terminal 310 transmits an operation request (also referred to as a restoration request) for performing restoration processing to the active system management server 210 to execute restoration processing.

When the operation on the virtual computer 260 of the active system terminates normally, a similar operation request is transmitted to the backup system management server 220. This similar operation request is transmitted even in a case where a normal termination occurs by restoration processing. An operation is performed on the virtual computer 260 of the backup system, and the administrator terminal 310 is notified of an operation result. In the case of an abnormal termination, the administrator terminal 310 transmits an operation request (restoration request) for performing restoration processing to the backup system management server 220 to execute restoration processing.

### Active System Management Server and Backup System Management Server

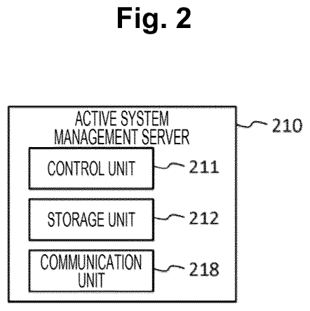

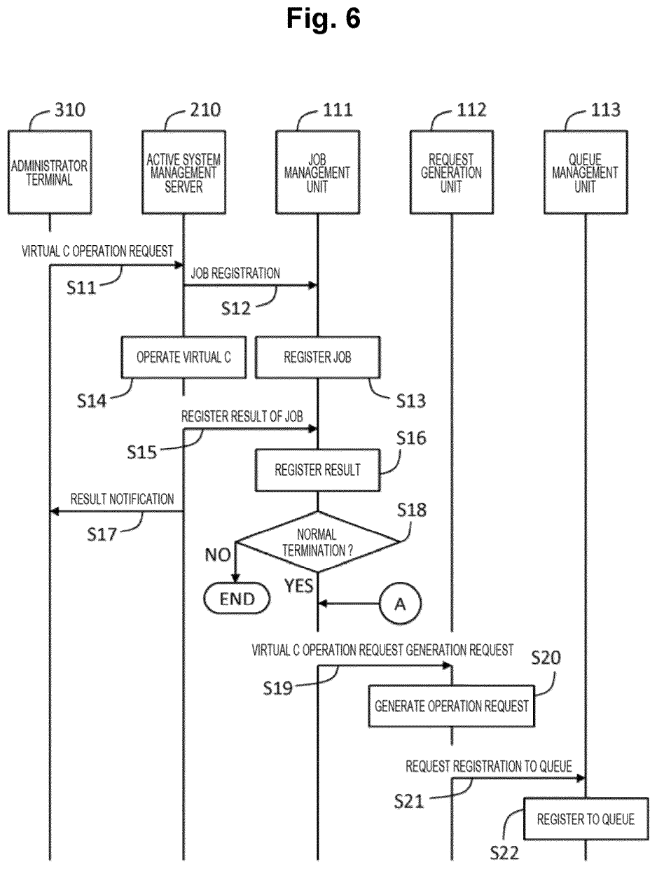

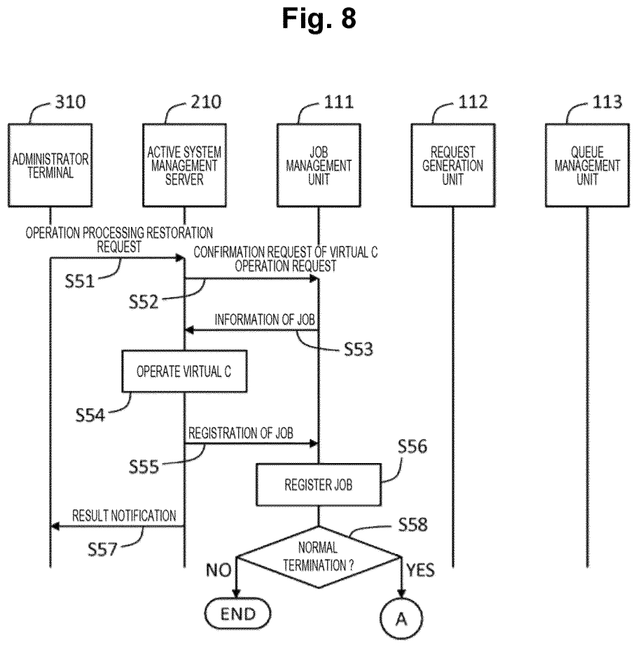

FIG. 2 is a function block diagram of the active system management server 210 according to the present embodiment. The active system management server 210 is a computer and includes a control unit 211, a storage unit 212, and a communication unit 218. The communication unit 218 is configured including a communication device, and transmits/receives communication data to/from the synchronization server 100, the virtualization infrastructure 250, and the administrator terminal 310. The storage unit 212 stores records of operations performed on the virtual computers 260. The control unit 211 receives an operation request for operating a virtual computer 260 from the administrator terminal 310 and, in response to the operation request, transmits instructions to the virtualization infrastructure 250 to operate the virtual computer 260. Other processing of the control unit 211 will be described later with reference to FIGS. 6 and 8.

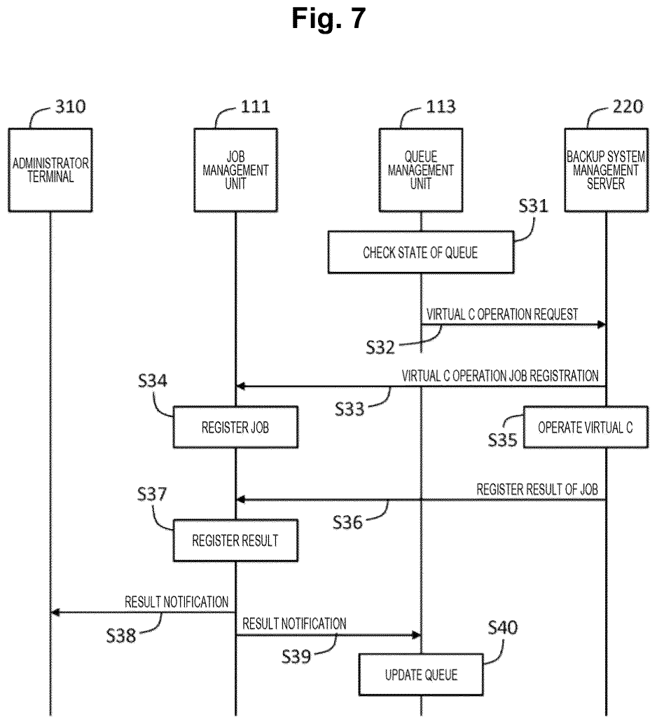

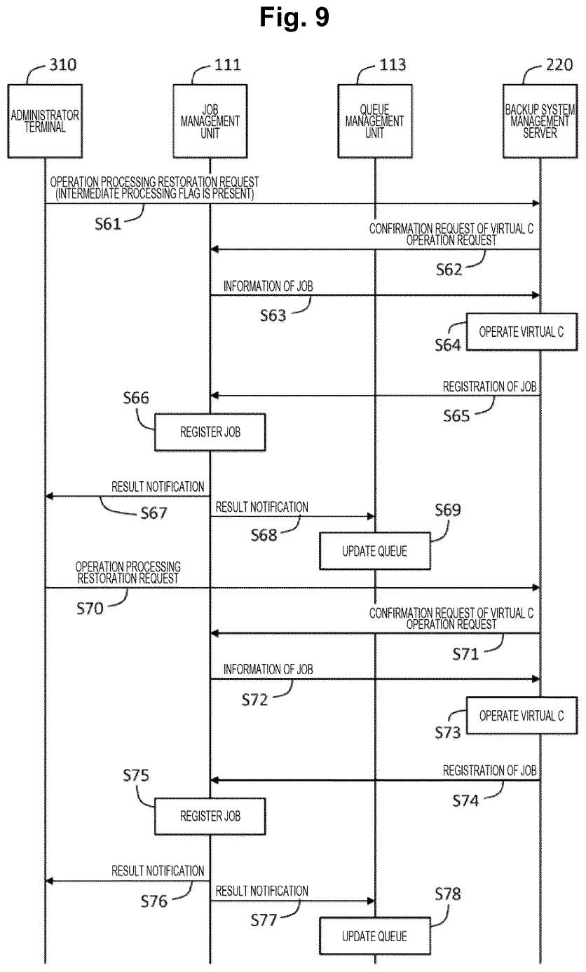

The function configuration of the backup system management server 220 is similar to that of the active system management server 210. Processing of the control unit of the backup system management server 220 will be described later with reference to FIGS. 7 and 9.

### Synchronization Server

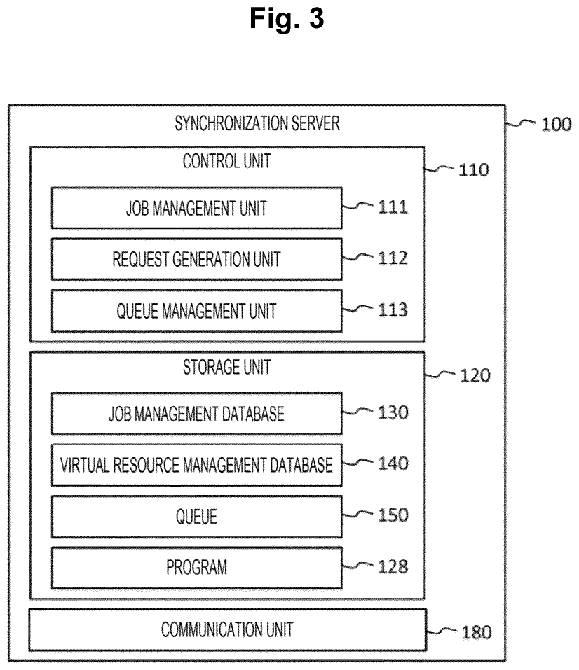

FIG. 3 is a function block diagram of the synchronization server 100 according to the present embodiment. The synchronization server 100 is a computer, and includes a control unit 110, a storage unit 120, and a communication unit 180. The communication unit 180 includes a communication device, and transmits/receives communication data to/from the active system management server 210 and the backup system management server 220.

### Synchronization Server—Storage Unit

The storage unit 120 is configured including a storage device such as a read only memory (ROM), a random access memory (RAM), and/or a solid state drive (SSD). The storage unit 120 stores a job management database 130, a virtual resource management database 140, a queue 150, and a program 128. The program 128 includes statements of processing (see FIGS. 6 to 10) of a job management unit 111, a request generation unit 112, and a queue management unit 113, which will be described later.

The queue 150 stores operation requests for operating virtual computers 260 of the backup system, which operation requestes are to be transmitted to the backup system management server 220. The operation request located at the head of the queue 150 is an operation request being processed by the backup system management server 220. After operation processing on a virtual computer 260 of the backup system in the backup system management server 220 terminates normally, the operation request is deleted from the queue 150, then the next operation request is transmitted to the backup system management server 220, and then operation processing on a virtual computer 260 of the backup system is started. The operation request remains at the head of the queue 150 until the pertinent operation processing terminates normally.

### Synchronization Server—Job Management Database

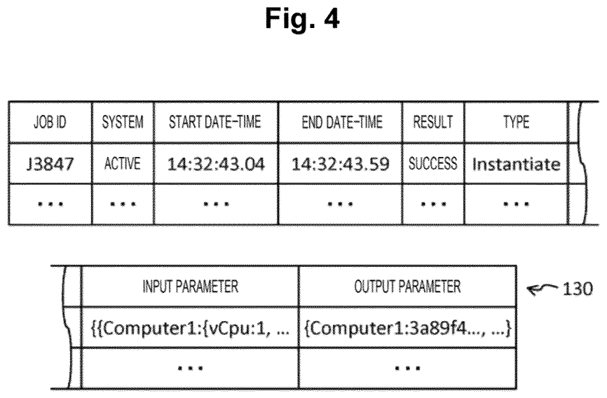

FIG. 4 is a data configuration diagram of the job management database 130 according to the present embodiment. The job management database 130 is tabular data in which one row (record) indicates an operation request (also referred to as a job) for the active system management server 210 or the backup system management server 220. A record of the job management database 130 includes columns (attributes) of: job identification information, system, start date-time, end date-time, result, type, input parameter, and output parameter.

The job identification information (denoted “Job ID” in FIG. 4) is identification information of a job (operation request). The system is “ACTIVE” or “BACKUP”, which indicates an operation request to (job for) the active system or an operation request to the backup system. The start date-time and the end date-time indicate the start date-time and the end date-time of the job. In FIG. 4, the start date-time and the end date-time are described only by time. The result is the result of the operation request and is “SUCCESS” or “FAILURE”, which indicates a normal termination or an abnormal termination, respectively. The type indicates the type of the operation request.

The input parameter is the input parameter of the operation request. The output parameter is the output parameter as the operation result of the operation request. Examples of the input parameter include the number of virtual central processing units (CPUs), the memory size, and the like of a virtual computer 260 to be instantiated in response to a request for instantiating a virtual computer 260. The output parameter in response to the instantiation request includes identification information indicating the instantiated virtual computer 260 as a virtual resource. Note that the virtual resources included in the input parameter and the output parameter are each indicated by a resource name or identification information of the virtual resource.

### Synchronization Server—Virtual Resource Management Database

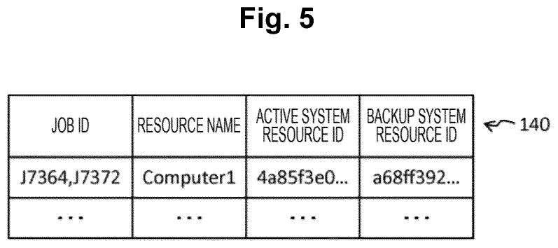

FIG. 5 is a data configuration diagram of the virtual resource management database 140 according to the present embodiment. The virtual resource management database 140 is tabular data in which one row (record) indicates correspondence between virtual resources of the active system and the backup system. A record of the virtual resource management database 140 includes columns (attributes) of: job identification information, resource name, active system resource identification information, and backup system resource identification information.

The job identification information is job identification information of corresponding operation requests for the active system management server 210 and the backup system management server 220. The resource name is a resource name related to the operation request. The active system resource identification information and the backup system resource identification information are respectively identification information on, of the active system and the backup system, virtual resources corresponding to the resource name. For example, when the operation request is a request for instantiating a virtual computer 260, the resource name is the resource name of the virtual computer 260 to be instantiated, and the active system resource identification information and the backup system resource identification information are identification information indicating the instantiated virtual computers 260 of the active system and the backup system as virtual resources.

### Synchronization Server—Control Unit

Referring back to FIG. 3, the control unit 110 will be described. The control unit 110 is configured including a CPU, and includes the job management unit 111, the request generation unit 112, and the queue management unit 113.

### Synchronization Server—Job Management Unit

The job management unit 111 receives, from the active system management server 210 and the backup system management server 220, registration of an operation request to be executed and registration of an execution result of the operation request and updates the job management database 130 and the virtual resource management database 140. For example, when the operation request is a instantiation request for instantiating a virtual computer 260, upon receiving registration of the operation request from the active system management server 210, the job management unit 111 adds a new record to the job management database 130 (see FIG. 4) and updates the job identification information, the system, the start date-time, the type, and the input parameter of the record. In addition, upon receiving registration of an execution result of the operation request, the job management unit 111 updates the end date-time, the result, and the output parameter. When the output parameter includes identification information of a newly instantiated virtual resource, the job management unit 111 adds a record to the virtual resource management database 140 (see FIG. 5) and updates the job identification information, resource name, and active system resource identification information of the record.

The same applies to the backup system management server 220. However, when the output parameter includes identification information of a newly instantiated virtual resource, the job management unit 111 searches the virtual resource management database 140 for a record including the job identification information and the resource name of the corresponding operation request of the active system management server 210 to retrieve the record, adds the job identification information of the operation request of the backup system management server 220 to the job identification information of the record, to update the backup system resource identification information.

When the operation of an operation request in the active system management server 210 terminates normally, the job management unit 111 instructs the request generation unit 112 to generate a pertinent operation request to the backup system management server 220.

### Synchronization Server—Request Generation Unit

The request generation unit 112 generates, for the backup system management server 220, an operation request corresponding to an operation request which is received by the active system management server 210 and which has been successfully terminated (normally terminated). When the operation request received by the active system management server 210 includes identification information of a virtual resource of the active system, the request generation unit 112 consults the virtual resource management database 140 (see FIG. 5) and replaces the identification information of the virtual resource with the identification information of the virtual resource of the backup system. For example, when the operation request is a request for connecting a virtual computer 260 to a virtual network, the identification information of the virtual resource of the virtual computer 260 in the active system and the identification information of the virtual resource of the virtual network in the active system are respectively replaced with the identification information of the virtual resource of the virtual computer 260 in the backup system and the identification information of the virtual resource of the virtual network in the backup system.

### Synchronization Server—Queue Management Unit

The queue management unit 113 adds (enqueues) the operation request to the backup system management server 220 generated by the request generation unit 112 to the queue 150. When an operation request located at the head of the queue 150 and last processed by the backup system management server 220 terminates normally and there is no intermediate processing flag described later, the queue management unit 113 deletes the operation request from the queue 150 and transmits the next operation request (operation request located at the head after deletion) to the backup system management server 220 to request processing of the operation request.

### Operation Request Processing—Operation Processing of Active System Virtual Computer

FIG. 6 is a sequence diagram of operation processing for a virtual computer 260 of the active system according to the present embodiment. Processing for an operation request (job) for the virtual computer 260, transmitted by the administrator terminal 310, will be described with reference to FIG. 6.

In step S11, the administrator terminal 310 transmits an operation request for operating a virtual computer 260 of the active system to the active system management server 210.

In step S12, the control unit of the active system management server 210 transmits a registration request for registration of the operation request (job) received in step S11 to the synchronization server 100. Hereinafter, processing of the control unit of the active system management server 210 will be referred to as processing of the active system management server 210.

In step S13, the job management unit 111 registers the operation request in the job management database 130 (see FIG. 4). More specifically, the job management unit 111 adds a new record to the job management database 130 and updates the job identification information, system, start date-time, type, and input parameter of the record.

In step S14, the active system management server 210 transmits an instruction corresponding to the operation request to the virtualization infrastructure 250, thereby to operate the virtual computer 260 (for example, instantiate the virtual computer 260).

In step S15, the active system management server 210 transmits a registration request for registration of the result of the operation in step S14 (result of the job) to the synchronization server 100.

In step S16, the job management unit 111 registers the operation result in the job management database 130. More specifically, the job management unit 111 updates the end date-time, result, and output parameter of the record updated in step S13. In addition, when the output parameter includes identification information of a newly instantiated virtual resource, the job management unit 111 adds a record to the virtual resource management database 140 (see FIG. 5) and updates the job identification information, resource name, and active system resource identification information of the record.

In step S17, the active system management server 210 notifies the administrator terminal 310 of the result of the operation (result of the job) in step S14 along with the operation identification information (job identification information).

In step S18, when the result of the operation in step S14, received in step S15, is a normal termination (step S18→YES), the job management unit 111 proceeds to step S19. If the result is an abnormal termination instead of a normal termination (step S18→NO), the job management unit 111 finishes the processing. In the case of an abnormal termination, as illustrated in below-described FIG. 8, the administrator terminal 310 transmits an operation request (restoration request) for restoration processing to the active system management server 210, thereby to execute the restoration processing for the operation (see step S14) on the virtual computer 260 of the active system. After this restoration processing terminates normally, processing is restarted from step S19.

In step S19, the job management unit 111 transmits, to the request generation unit 112, a request for generation of an operation request, corresponding to the operation request in step S11, for operating a virtual computer 260 of the backup system.

In step S20, the request generation unit 112 generates the operation request for operating the virtual computer 260 of the backup system. When the operation request received by the active system management server 210 includes identification information of a virtual resource of the active system, the request generation unit 112 consults the virtual resource management database 140 (see FIG. 5) and replaces the identification information of the virtual resource with the identification information of the virtual resource of the backup system.

In step S21, the request generation unit 112 transmits the generated operation request to the queue management unit 113 to request registration to the queue 150.

In step S22, the queue management unit 113 registers the operation request in the queue 150 (appends the operation request to the end of the queue 150).

### Operation Request Processing—Operation Processing of Backup System Virtual Computer

FIG. 7 is a sequence diagram of operation processing for a virtual computer 260 of the backup system according to the present embodiment. The processing in the backup system with respect to an operation request for operating the virtual computer 260 (see step S11 in FIG. 6), transmitted by the administrator terminal 310, will be described with reference to FIG. 7.

In step S31, the queue management unit 113 checks the state of the queue 150. More specifically, if the state of the operation request located at the head of the queue 150 is a normal termination and there is no intermediate processing flag described later (when OFF), the queue management unit 113 deletes the operation request from the queue 150 and proceeds to step S32. The queue management unit 113, if the state of the operation request is not a normal termination or the intermediate processing flag is ON, waits for a predetermined period of time.

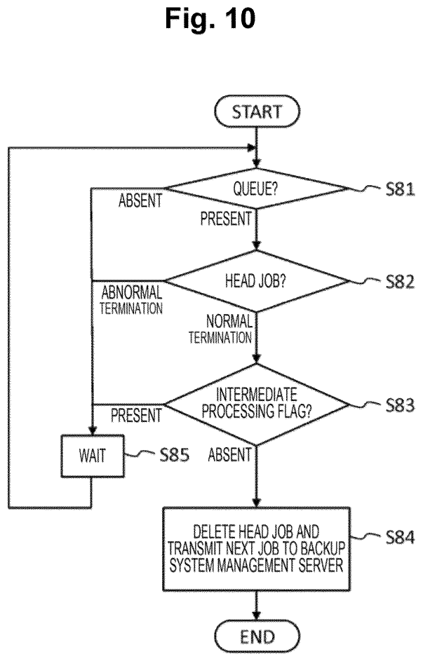

In step S32, the queue management unit 113 transmits the operation request located at the head of the queue 150 to the backup system management server 220. Note that the processing of the queue management unit 113 in steps S31 and S32 will be described with reference to below-described FIG. 10.

Steps S33 to S37 are similar to steps S12 to S16 illustrated in FIG. 6 (the active system management server 210 is read as the backup system management server 220). Note that the virtual computer 260 to be operated is of a backup system. In step S37, when the output parameter includes identification information of a newly instantiated virtual resource, the job management unit 111 searches the virtual resource management database 140 (see FIG. 5) for a record including the job identification information and the resource name of the corresponding operation request of the active system management server 210 to retrieve the record, adds the job identification information of the operation request of the backup system management server 220 to the job identification information of the record, to update the backup system resource identification information. Hereinafter, processing of the control unit of the backup system management server 220 will be referred to as processing of the backup system management server 220.

In step S38, the job management unit 111 notifies the administrator terminal 310 of the result of the operation (result of the job) in step S35 along with the operation identification information (job identification information).

In step S39, the job management unit 111 notifies the queue management unit 113 of the result of the operation in step S35.

In step S40, the queue management unit 113 updates the state of the operation request located at the head of the queue 150. The operation request located at the head of the queue 150 is the operation request transmitted to the backup system management server 220 in step S32. The queue management unit 113 updates the state of the operation request to “normal termination” or “abnormal termination” according to the operation result. As described regarding steps S31 and S32, in the case of a normal termination, the operation request is deleted from the queue 150, and the next operation request is transmitted to the backup system management server 220. In the case of an abnormal termination, as illustrated in below-described FIG. 9, the administrator terminal 310 transmits an operation request for restoration processing to the backup system management server 220, thereby to execute the restoration processing for the operation (see step S35) on the virtual computer 260 of the backup system.

After this restoration processing terminates normally, the operation request is deleted from the queue 150, and the next operation request is transmitted to the backup system management server 220.

### Operation Request Processing—Restoration Processing of Active System Virtual Computer

FIG. 8 is a sequence diagram of restoration processing for a virtual computer 260 of the active system according to the present embodiment. This processing is processing, in FIG. 6, after the operation on the virtual computer 260 of the active system in step S14 terminates abnormally (fails), the administrator terminal 310 is notified of the abnormal termination in step S17 and processing of the job management unit 111 terminates in step S18. Upon receiving the notification, the administrator terminal 310 starts restoration processing.

In step S51, the administrator terminal 310 transmits, to the active system management server 210, a restoration request for restoration for the operation (operation processing) for the operation request (see step S11) for the virtual computer 260 of the active system. This restoration request includes identification information (job identification information, see step S17) of the operation processing.

In step S52, the active system management server 210 transmits the identification information included in the request received in step S51 to the synchronization server 100, to request information pertinent to the failed operation request for operation on the virtual computer 260 of the active system.

In step S53, the job management unit 111 consults the job management database 130 (see FIG. 4) and transmits information on the operation processing (job) pertinent to the operation request corresponding to the identification information to the active system management server 210.

In step S54, the active system management server 210 transmits an instruction to the virtualization infrastructure 250 as restoration processing addressing the failed operation processing, thereby to operate the virtual computer 260. The restoration processing may be, for example, re-execution of the same operation or re-execution with correction of an input parameter.

In step S55, the active system management server 210 transmits a registration request for registration of the content and result of the operation (job) in step S54 to the synchronization server 100.

In step S56, the job management unit 111 registers the content and result of the operation in the job management database 130. More specifically, the job management unit 111 adds a new record to the job management database 130 and updates the job identification information, system, start date-time, end date-time, result, type, input parameter, and output parameter of the record. When the output parameter includes identification information of a newly instantiated virtual resource, the job management unit 111 adds a record to the virtual resource management database 140 (see FIG. 5) and updates the job identification information, resource name, and active system resource identification information of the record.

Steps S57 and S58 are similar to steps S17 and S18. In the case of a normal termination (step S58→YES), the job management unit 111 proceeds to step S19 to transmit, to the request generation unit 112, a request for generation of an operation request for operating a virtual computer 260 of the backup system, the operation request corresponding to the operation (see step S54) for the virtual computer 260 of the active system that has terminated normally. In the case of an abnormal termination, the processing of FIG. 8 is repeated.

### Operation Request Processing—Restoration Processing of Backup System Virtual Computer

FIG. 9 is a sequence diagram of restoration processing for a virtual computer 260 of the backup system according to the present embodiment. This processing is processing, in FIG. 7, after the operation on the virtual computer 260 of the backup system in step S35 terminates abnormally (fails), the administrator terminal 310 is notified of the abnormal termination in step S38 and processing of the synchronization server 100 terminates in step S40. Upon receiving the notification, the administrator terminal 310 starts restoration processing. Note that this restoration processing is not necessarily completed by one restoration request, and a plurality of restoration requests may be required. In the following description, a case where restoration processing includes two restoration requests will be described. When there are a plurality of restoration requests, the restoration requests except for the last restoration request include an intermediate processing flag.

In step S61, the administrator terminal 310 transmits, to the backup system management server 220, a restoration request for restoration for the operation (operation processing) for the operation request (see step S32) for the virtual computer 260 of the backup system. This restoration request includes identification information (job identification information, see step S38) of the operation processing and an intermediate processing flag.

Steps S62 to S67 are similar to steps S52 to S57 (the active system management server 210 is read as the backup system management server 220). However, processing for the virtual resource management database 140 (see FIG. 5) is similar to the processing in step S37. Notification of the result in step S67 is transmitted by the job management unit 111.

In step S68, the job management unit 111 notifies the queue management unit 113 of the result of the operation in step S64.

In step S69, the queue management unit 113 updates the state of the operation request located at the head of the queue 150. The operation request located at the head of the queue 150 is the operation request transmitted to the backup system management server 220 in step S32 (see FIG. 7). The queue management unit 113 updates the state of the operation request to “normal termination” or “abnormal termination” according to the operation result. As the restoration request (see step S61) includes an intermediate processing flag, the queue management unit 113 sets the intermediate processing flag in the operation request (sets the intermediate processing flag to ON). It is assumed that the first restoration request has terminated normally, and description of the second restoration request will be continued.

Steps S70 to S78 are similar to steps S61 to S69. However, the restoration request in step S70 does not include the intermediate processing flag. In step S78, the queue management unit 113 does not sets the intermediate processing flag in the operation request located at the head of the queue 150 (sets the intermediate processing flag to OFF). When the restoration processing terminates normally, the operation request is deleted from the queue 150, and the next operation request is transmitted to the backup system management server 220 (see steps S31 and S32).

### Queue Management Processing

FIG. 10 is a flowchart of management processing of the queue 150 according to the present embodiment. The processing in steps S31 and S32 (see FIG. 7) will be described in detail with reference to FIG. 10.

In step S81, the queue management unit 113 proceeds to step S82 if there is an operation request (job) in the queue 150 (step S81→present), and proceeds to step S85 if not (step S81→absent).

In step S82, the queue management unit 113 proceeds to step S83 if the state of the job (operation request) located at the head is a normal termination (step S82→normal termination), and proceeds to step S85 if the state is not a normal termination (step S82→abnormal termination).

In step S83, the queue management unit 113 proceeds to step S84 if the job located at the head does not include an intermediate processing flag (step S83→absent), and proceeds to step S85 if the job includes an intermediate processing flag (step S83→present).

In step S84, the queue management unit 113 deletes the job located at the head from the queue 150, and transmits the next job newly located at the head to the backup system management server 220 (see step S32).

In step S85, the queue management unit 113 waits for a predetermined period of time and returns to step S81.

### Features of Virtual Computer Management System

Operation requests for a virtual computer 260 of the backup system are managed by the queue 150, and operation requests that have terminated normally (step S18→YES in FIG. 6; see steps S19 to S22) in the active system are sequentially processed. Therefore, the active system management server 210 can process operation requests requested from the administrator terminal 310 without waiting for termination of an operation on the virtual computer 260 of the backup system. The operation content and order of the operations on the virtual computer 260 of the active system are the same as those of the operations on the virtual computer 260 of the backup system, and thus synchronization is guaranteed.

An operation request to the backup system is an operation request that has terminated normally in the active system, and thus the occurrence of an abnormal termination similar to an abnormal termination occurring in the active system can be reduced. In addition, restoration processing can also be reduced, and thus the efficiency of operating the virtual computer 260 is improved.

Even if the same operation is attempted to be performed on the virtual computers 260, the active system and the backup system cannot perform exactly the same operation because target virtual resources are different. By providing the virtual resource management database 140 (see FIG. 5), the virtual computer management system 10 can manage correspondence of the virtual resources used by the active system and the virtual resources used by the backup system and can perform operations equivalent to those on the active system on the backup system.

### Modification Example—Intermediate Processing Flag

In restoration processing in the backup system, when the administrator terminal 310 sends a plurality of restoration requests to the backup system management server 220, the administrator terminal 310 sends the restoration requests each including an intermediate processing flag except for the last restoration request (see step S61 in FIG. 9). The state of the operation request located at the head of the queue 150 includes the intermediate processing flag regardless of whether the corresponding restoration request has terminated normally or terminated abnormally.

Instead of the intermediate processing flag being included in an operation request in the queue 150, in the case of a restoration request including an intermediate processing flag, the state of the operation request located at the head of the queue 150 may be determined as an abnormal termination regardless whether the state is normal termination or abnormal termination. In other words, the queue management unit 113 may, when a restoration request not including an intermediate processing flag (the last restoration request in the restoration processing) has terminated normally, determine the state of the operation request located at the head of the queue 150 as a normal termination (determine that the state is an abnormal termination in step S69 and a normal termination in step S78).

### Modification Example—Plural Backup Systems

Although there is one backup system in the above-described embodiment, there may be a plurality of backup systems. When there are a plurality of backup systems, the backup system management server 220 and the queue 150 may be provided for each backup system to generate operation requests (see step S20). The virtual resource management database 140 (see FIG. 5) includes an attribute of backup system resource identification information for each backup system. When a backup system terminates abnormally, restoration processing (see FIG. 9) will be performed in that backup system.

### Modification Example—Queue Management

In the above-described embodiment, after an operation on the virtual computer 260 in the backup system terminates normally, an operation request corresponding to the operation is deleted from the queue 150, and the operation request located at the head after deletion is transmitted to the backup system management server 220. Instead of such processing, the queue management unit 113 may, after consulting the job management database 130 (see FIG. 4) to confirm that the last operation request transmitted to the backup system management server 220 has terminated normally or that when the last operation request has terminated abnormally, a restoration processing (last restoration request) has terminated normally, transmit the operation request located at the head of the queue 150 to the backup system management server 220 and delete the operation request from the queue 150.

### Other Modifications

Although certain embodiments of the present invention have been described above, these embodiments are merely examples and do not limit the technical scope of the present invention. For example, the active system management server 210 and the backup system management server 220 each register a job (operation request) in the synchronization server (see steps S12 to S13 and S33 to S34) before operating the virtual computer 260 (see steps S14 and S35). Instead of this, the content of the job may be registered in registration of the result of the job (see steps S15 and S36).

The present invention can take various other embodiments, and various changes such as omission and replacement can be made without departing from the gist of the present invention. These embodiments and modifications thereof are included in the scope and gist of the invention described in the present specification and the like, and are included in the invention described in the claims and the equivalent scope thereof.

### Hardware Configuration

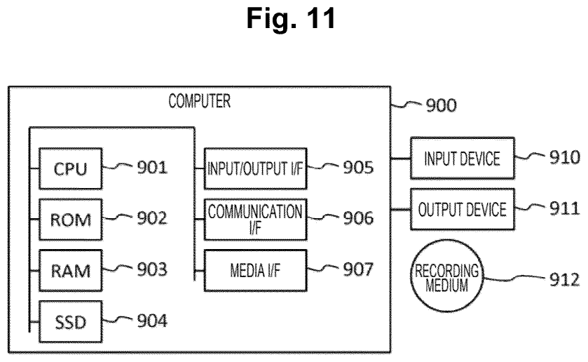

The synchronization server 100 according to the above-described embodiment is implemented by a computer 900 having the configuration as illustrated in FIG. 11, for example. FIG. 11 is a hardware configuration diagram illustrating an example of the computer 900 that implements the functions of the synchronization server 100 according to the present embodiment. The computer 900 includes a CPU 901, a ROM 902, a RAM 903, an SSD 904, an input/output interface 905 (denoted as input/output I/F in FIG. 11), a communication interface 906 (denoted as communication I/F in FIG. 11), and a media interface 907 (denoted as media I/F in FIG. 11). The computer 900 may include a hard disc drive (HDD) instead of the SSD 904, or may further include an HDD in addition to the SSD 904.

The CPU 901 operates according to a program stored in the ROM 902 or the SSD 904, and performs control by the control unit 110 illustrated in FIG. 3. The ROM 902 stores a boot program executed by the CPU 901 when the computer 900 is activated, a program related to the hardware of the computer 900, and the like.

The CPU 901 controls an input device 910 such as a mouse and a keyboard and an output device 911 such as a display and a printer via the input/output interface 905. The CPU 901 acquires data from the input device 910 and outputs generated data to the output device 911 via the input/output interface 905.

The SSD 904 stores a program to be executed by the CPU 901, data to be used by the program, and the like. The communication interface 906 receives data from another, not-illustrated device (for example, the active system management server 210 or the like) via a communication network, outputs the data to the CPU 901, and transmits data generated by the CPU 901 to another device via a communication network.

The media interface 907 reads a program or data stored in a recording medium 912 and outputs the program or data to the CPU 901 via the RAM 903. The CPU 901 loads the program from the recording medium 912 into the RAM 903 via the media interface 907, and executes the loaded program. The recording medium 912 is an optical recording medium such as a digital versatile disk (DVD), a magneto-optical recording medium such as a magneto optical disk (MO), a magnetic recording medium, a conductor memory tape medium, a semiconductor memory, or the like.

For example, in a case where the computer 900 functions as the synchronization server 100 according to the above-described embodiment, the CPU 901 of the computer 900 implements the functions of the synchronization server 100 by executing the program 128 (see FIG. 3) loaded on the RAM 903. The CPU 901 reads the program from the recording medium 912 and executes the program. Additionally, the CPU 901 may read the program from another device via the communication network, or may install the program 128 from the recording medium 912 to the SSD 904 and execute the program 128.

### Effects

Effects of the device will be described below.

A virtual computer management system 10 according to the above-described embodiment is configured including an active system management server 210 and a backup system management server 220 that receive an operation request for operating a virtual computer.

The virtual computer management system 10 includes: a request generation unit 112 that, when an operation result of the active system management server 210 is a normal termination, converts an operation request to the active system management server 210 into an operation request to the backup system management server 220, and a queue management unit 113 that: enqueues the operation request to the backup system management server 220 in a queue 150 storing the operation request; and when a result of an operation in response to a last operation request, at the head of the queue 150, for backup system management server 220 to operate a virtual computer 260 is a normal termination, deletes the operation request from the queue 150 and transmits an operation request newly located at the head of the queue 150 to the backup system management server 220 to request processing.

According to this virtual computer management system 10, operation requests for operating virtual computers 260 of the backup system are managed by the queue 150, and operation requests that have terminated normally in the active system are sequentially processed. Therefore, the active system management server 210 can process operation requests requested from an administrator terminal 310 without waiting for termination of an operation on the virtual computer 260 of the backup system. In addition, the operation content and order of the operations on the virtual computer 260 of the active system are the same as those of the operations on the virtual computer 260 of the backup system, and thus synchronization is guaranteed.

An operation request to the backup system is an operation request that has terminated normally in the active system, and thus the occurrence of an abnormal termination similar to an abnormal termination occurring in the active system can be reduced. In addition, restoration processing can also be reduced, and thus the efficiency of operating the virtual computer 260 is improved.

The virtual computer management system 10 according to the above-described embodiment is configured including: the active system management server 210 and the backup system management server 220 that receive an operation request for operating a virtual computer 260; and a synchronization server 100.

The active system management server 210, upon receiving an operation request, operates the virtual computer 260 of the active system and notify the synchronization server 100 of an operation result.

The synchronization server 100 includes: a job management unit 111 that receives the operation result of the active system management server 210 and an operation result of the backup system management server 220, the request generation unit 112, which converts an operation request to the active system management server 210, output by the job management unit 111 when the operation result of the active system management server 210 is a normal termination, into an operation request to the backup system management server 220, and the queue management unit 113, which: enqueues the operation request to the backup system management server 220 in the queue 150 storing the operation request; and when a result of an operation in response to a last operation request, at a head of the queue, for the backup system management server 220 to operate a virtual computer 260 is a normal termination, deletes the operation request from the queue 150 and transmits an operation request newly located at the head of the queue 150 to the backup system management server 220 to request processing.

The backup system management server 220, upon receiving an operation request located at the head of the queue 150, operates the virtual computer 260 of the backup system and notifies the synchronization server 100 of the operation result.

According to this virtual computer management system 10, the active system management server 210 and the backup system management server 220 operate the virtual computers 260 of the active system and the backup system, respectively. Operation requests for operating the virtual computer 260 of the backup system are managed by the queue 150, and operation requests that have terminated normally in the active system are sequentially processed. Therefore, the active system management server 210 can process an operation request requested from the administrator terminal 310 without waiting for termination of an operation on the virtual computer 260 of the backup system. In addition, the operation content and order of the operations on the virtual computer 260 of the active system are the same as those of the operations on the virtual computer 260 of the backup system, and thus synchronization is guaranteed.

An operation request to the backup system is an operation request that has terminated normally in the active system, and thus the occurrence of an abnormal termination similar to an abnormal termination occurring in the active system can be reduced. In addition, restoration processing can also be reduced, and thus the efficiency of operating the virtual computer 260 is improved.

The synchronization server 100 according to the above-described embodiment includes a storage unit 120 that stores a virtual resource management database 140 (see FIG. 5) in which a resource name related to an operation request, identification information of a virtual resource having the resource name and related to the operation request to the active system management server 210, and identification information of a virtual resource having the resource name and related to the operation request to the backup system management server 220 are stored associated with one another.

The request generation unit 112, when converting an operation request to the active system management server 210 into an operation request to the backup system management server 220, consults the virtual resource management database 140 and replaces identification information of a virtual resource having a resource name included in the operation request to the active system management server 210 with identification information of a virtual resource having the resource name included in the operation request to the backup system management server 220.

Even if the same operation is attempted to be performed on the virtual computers 260, the active system and the backup system cannot perform exactly the same operation because target virtual resources are different. By providing the virtual resource management database 140, the synchronization server 100 can manage correspondence of the virtual resources used by the active system and the virtual resources used by the backup system and can perform operations equivalent to those on the active system on the backup system.

The job management unit 111 according to the above-described embodiment, upon receiving operation results from the active system management server 210 and the backup system management server 220, acquires identification information included in the operation results and indicative of newly instantiated virtual resources and updates the virtual resource management database 140.

According to this virtual computer management system 10, the virtual resource management database 140 can reflect the latest use states of the virtual resources of the active system and the backup system. As a result, the request generation unit 112 can accurately convert an operation request to the active system management server 210 into an operation request to the backup system management server 220.

The queue management unit 113, when restoration processing to be performed in a case where the operation on the virtual computer 260 by the backup system management server 220 according to the above-described embodiment terminates abnormally includes a plurality of operations (restoration requests) and when the operation result of the last operation of the plurality of operations is a normal termination, deletes the operation request located at the head of the queue 150 from the queue 150 and transmits the operation request newly located at the head of the queue 150 to the backup system management server 220 to request processing.

According to this virtual computer management system 10, even when restoration processing (see FIG. 9) in the backup system is executed by a plurality of restoration requests, the next operation request to the backup system management server 220 is executed after all the restoration processes are executed and terminated normally. The next operation request is not started in the middle of restoration processing, and thus the synchronization between the active system and the backup system is guaranteed.

### REFERENCE SIGNS LIST

10 Virtual computer management system
100 Synchronization server
111 Job management unit
112 Request generation unit
113 Queue management unit
128 Program
130 Job management database
140 Virtual resource management database
150 Queue
210 Active system management server
220 Backup system management server
260 Virtual computer

1-7. (canceled)

8. A virtual computer management system comprising:
a request generation unit; and
a queue management unit,
wherein the request generation unit is implemented using one or more processors and configured to, when a result of an operation performed by an active system management server in response to a first operation request for operating a first virtual computer of an active system is a normal termination, convert the first operation request into a second operation request requesting a backup system management server to operate a second virtual computer of a backup system, and
wherein the queue management unit is implemented using one or more processors and configured to:
enqueue the second operation request in a queue; and
when a result of an operation performed by the backup system management server in response to a third operation request located at a head of the queue is a normal termination, the third operation request requesting the backup system management server to operate a third virtual computer of the backup system, delete the third operation request from the queue and transmit an operation request newly located at the head of the queue to the backup system management server to request processing.

9. The virtual computer management system according to claim 8, further comprising:
the active system management server;
the backup system management server; and
a synchronization server comprising a job management unit, the request generation unit, and the queue management unit,
wherein the active system management server is implemented using one or more processors and configured to, upon receiving the first operation request for operating the first virtual computer of the active system, operate the first virtual computer according to the first operation request and notify the synchronization server of the result of the operation performed by the active system management server in response to the first operation request,
wherein the job management unit is configured to:
receive the result of the first operation request from the active system management server; and,
when the received result of the first operation request is a normal termination, output the first operation request to the request generation unit,
wherein the request generation unit is configured to convert the first operation request output from the job management unit into the second operation request,
wherein the queue management unit is further configured to transmit the third operation request located at the head of the queue to the backup system management server,
wherein the backup system management server is implemented using one or more processors and configured to, upon receiving the third operation request from the synchronization server, operate the third virtual computer according to the third operation request and notify the synchronization server of the result of the third operation request, and
wherein the job management unit is further configured to receive the result of the third operation request from the backup system management server.

10. The virtual computer management system according to claim 9,
wherein the synchronization server further comprises a storage unit that stores a virtual resource management database including records each including:
a resource name;
first identification information of a first virtual resource of the active system, the first virtual resource having the resource name and related to an operation request for operating the first virtual resource; and
second identification information of a second virtual resource of the backup system, the second virtual resource having the resource name and related to an operation request for operating the second virtual resource, and
wherein the request generation unit is further configured to, when converting the first operation request into the second operation request, consult the virtual resource management database and, if the first operation request includes identification information corresponding to the first identification information included in a record of the records included in the virtual resource management database, replace the identification information included in the first operation request with the second identification information included in the record.

11. The virtual computer management system according to claim 10,
wherein the job management unit is further configured to, when an operation result, which is any one of the result of the first operation request and the result of the third operation request, includes identification information of a newly instantiated virtual resource, updates the virtual resource management database based on the identification information of the newly instantiated virtual resource.

12. The virtual computer management system according to claim 9,
wherein the queue management unit is further configured to, when restoration processing to be performed in a case where the result of the operation performed by the backup system management server in response to the third operation request is an abnormal termination includes a plurality of operations and when an operation result of a last operation of the plurality of operations is a normal termination, delete the third operation request from the queue and transmits the operation request newly located at the head of the queue to the backup system management server to request processing.

13. A synchronization server of a virtual computer management system configured including an active system management server and a backup system management server, each configured to receive an operation request for operating a virtual computer and perform an operation in response to the operation request, the synchronization server implemented using one or more processors and comprising:
a job management unit;
a request generation unit; and
a queue management unit,
wherein the job management unit is configured to:
receive a result of a first operation request for operating a first virtual computer of an active system from the active system management server; and
when the received result of the first operation request is a normal termination, output the first operation request to the request generation unit,
wherein the request generation unit is configured to convert the first operation request output from the job management unit into a second operation request requesting the backup system management server to operate a second virtual computer of a backup system,
wherein the queue management unit is configured to;
enqueue the second operation request into a queue; and
transmit a third operation request located at a head of the queue to the backup system management server, the third operation request requesting the backup system management server to operate a third virtual computer of the backup system,
wherein the job management unit is further configured to receive a result of the third operation request from the backup system management server,
wherein the queue management unit is further configured to, when the result of the third operation request is a normal termination, delete the third operation request from the queue and transmit an operation request newly located at the head of the queue to the backup system management server to request processing.

14. The synchronization server according to claim 13,
wherein the synchronization server further comprises a storage unit that stores a virtual resource management database including records each including:
a resource name;
first identification information of a first virtual resource of the active system, the first virtual resource having the resource name and related to an operation request for operating the first virtual resource; and
second identification information of a second virtual resource of the backup system, the second virtual resource having the resource name and related to an operation request for operating the second virtual resource, and
wherein the request generation unit is further configured to, when converting the first operation request into the second operation request, consult the virtual resource management database and, if the first operation request includes identification information corresponding to the first identification information included in a record of the records included in the virtual resource management database, replace the identification information included in the first operation request with the second identification information included in the record.

15. The synchronization server according to claim 14,
wherein the job management unit is further configured to, when an operation result, which is any one of the result of the first operation request and the result of the third operation request, includes identification information of a newly instantiated virtual resource, updates the virtual resource management database based on the identification information of the newly instantiated virtual resource.

16. The synchronization server according to claim 13,
wherein the queue management unit is further configured to, when restoration processing to be performed in a case where the result of the operation performed by the backup system management server in response to the third operation request is an abnormal termination includes a plurality of operations and when an operation result of a last operation of the plurality of operations is a normal termination, delete the third operation request from the queue and transmits the operation request newly located at the head of the queue to the backup system management server to request processing.

17. A computer-implemented method of managing virtual computers, the method to be executed by a virtual computer management system including an active system management server, a backup system management server, and a synchronization server, the method comprising:
by the active system management server, upon receiving a first operation request for operating a first virtual computer of an active system,
operating the first virtual computer according to the first operation request, and
communicating a result of the first operation request to the synchronization server;
by the synchronization server,
receiving the result of the first operation request from the active system management server,
when the result of the first operation request is a normal termination, converting the first operation request into a second operation request requesting the backup system management server to operate a second virtual computer of a backup system,
enqueuing the second operation request into a queue,
transmitting a third operation request located at a head of the queue to the backup system management server, the third operation request requesting the backup system management server to operate a third virtual computer of the backup system,
receiving a result of the third operation request from the backup system management server, and
when the result of the third operation request is a normal termination, deleting the third operation request from the queue and transmitting an operation request newly located at the head of the queue to the backup system management server; and
by the backup system management server, upon receiving the third operation request from the synchronization server, operating the third virtual computer according to the third operation request and communicating the result of the third operation request to the synchronization server.
